(19) United States
(12) Patent Application Publication
(10) Pub. No.: US 2010/0252966 A1
(43) Pub. Date: Oct. 7, 2010

(54) PRECIOUS METAL RECOVERY DEVICE

(76) Inventors: Chin-Hsiung YANG, Da-Yuan Hsiang (TW); Hsin-Yi TSAI, Da-Yuan Hsiang (TW)

Correspondence Address: SINORICA, LLC, 2275 Research Blvd., Suite 500, ROCKVILLE, MD, 20850, US

(21) Appl. No.: 12/488,918

(22) Filed: Jun. 22, 2009

(30) Foreign Application Priority Data
Apr. 1, 2009 (TW) 098110956

(51) Int. Cl. C22B 9/00; B25J 18/00

(52) U.S. Cl. 266/96; 74/490.01

(57) ABSTRACT

A precious metal recovery device is revealed. A robot arm holds a cover of at least one loader for opening and moving the cover so as to put an object in or move an object out the loader. The loader is a pentagonal prism with an opening on one side thereof. The area of the opening is enlarged for convenience of loading objects containing precious metal. The loader is to receive the object containing the precious metal. By means of a conveying device, the loader is carried to an immersion device, at least one dissolver and at least one water cleaning device in sequence so as to recover precious metal from the objects containing precious metal. The precious metal recovery device recovers the precious metal continuously and automatically. Therefore, the speed of precious metal recovery is improved and the amount of precious metal recovered is increased.

### BACKGROUND OF THE INVENTION

1. Field of Invention

The present invention relates to a recovery device, especially to a precious metal recovery device.

2. Description of Related Art

The fast development of modern technology results in booming development of electronic industries. The waste derived from electronic components is growing. The waste includes copper, lead, aluminum, iron, precious metal and so on. The waste treatment and recovery becomes an important issue. Without being treated or recovered properly, the waste causes environmental pollution. Moreover, in consideration of value and use of precious metal, this is a great waste of resources.

The treatment and recovery of waste containing metal focuses on recovery of valuable metal such as gold and palladium, precious metal of high economic value. For example, main sources of waste containing gold are integrated circuit boards and printed circuit boards. In the integrated circuit industry, a great amount of waste containing gold is produced during processes of thin film formation and coating. Other waste includes the molds used and disposed, waste derived from evaporation materials during thin film formation and coating processes, waste solution produced during gold coating process, wafer waste containing gold, gold powder, spent resin containing gold, spent catalyst containing gold, and used iodine solution containing gold.

There is a trend toward smaller size, thinner profile and higher efficiency in electronic industries so that material selection and development is getting more important. For example, palladium is considered as an optimal electrode material for multilayer ceramic capacitors in industries due to high conductivity and low reactivity at high temperature. However, the palladium is quite expensive. Thus while developing cladding materials containing palladium alloy, the effective recovery and reuse of palladium is also quite important.

There is no systemized precious metal recovery device available now. Most of precious metal recovery is done by manual labor. Thus there is a need to invent a systemized precious metal recovery device that raises speed of precious metal recovery and increases the amount of precious metal recovered.

### SUMMARY OF THE INVENTION

Therefore it is a primary object of the present invention to provide a precious metal recovery device that recovers precious metal continuously with higher recovery speed and larger recovery amount.

It is another object of the present invention to provide a precious metal recovery device that recovers precious metal automatically.

It is a further object of the present invention to provide a precious metal recovery device that includes a pentagonal-prism shaped loader with an opening on one side thereof. The area of the opening is enlarged for convenience of loading objects with precious metal.

It is a further object of the present invention to provide a precious metal recovery device in which a cover of a loader is moved by a robot arm so as to put objects in or move objects out the loader. The robot arm can replace manual labor.

In order to achieve above objects, a precious metal recovery device of the present invention consists of a conveying device, at least one loader, a robot arm, an immersion device, at least one dissolver and at least one water cleaning device. The loader is a pentagonal prism with an opening and a cover on one side thereof. The robot arm holds the cover for opening and moving the cover. The loader is disposed on the conveying device so as to be sent to the immersion device, the dissolver or the water cleaning device. The loader is to receive an object containing precious metal. The loader with the object containing precious metal is moved to the immersion device, the dissolver and the water cleaning device in order by the conveying device so as to recover the precious metal.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing an embodiment according to the present invention;

FIG. 2 is a perspective view of an embodiment of a loader according to the present invention;

FIG. 3 is a perspective view of another embodiment of a loader according to the present invention;

FIG. 4 is a schematic drawing showing another embodiment according to the present invention;

FIG. 5 is a schematic drawing showing an embodiment of a water drainage member according to the present invention.

### DETAILED DESCRIPTION OF THE PREFERRED EMBODIMENT

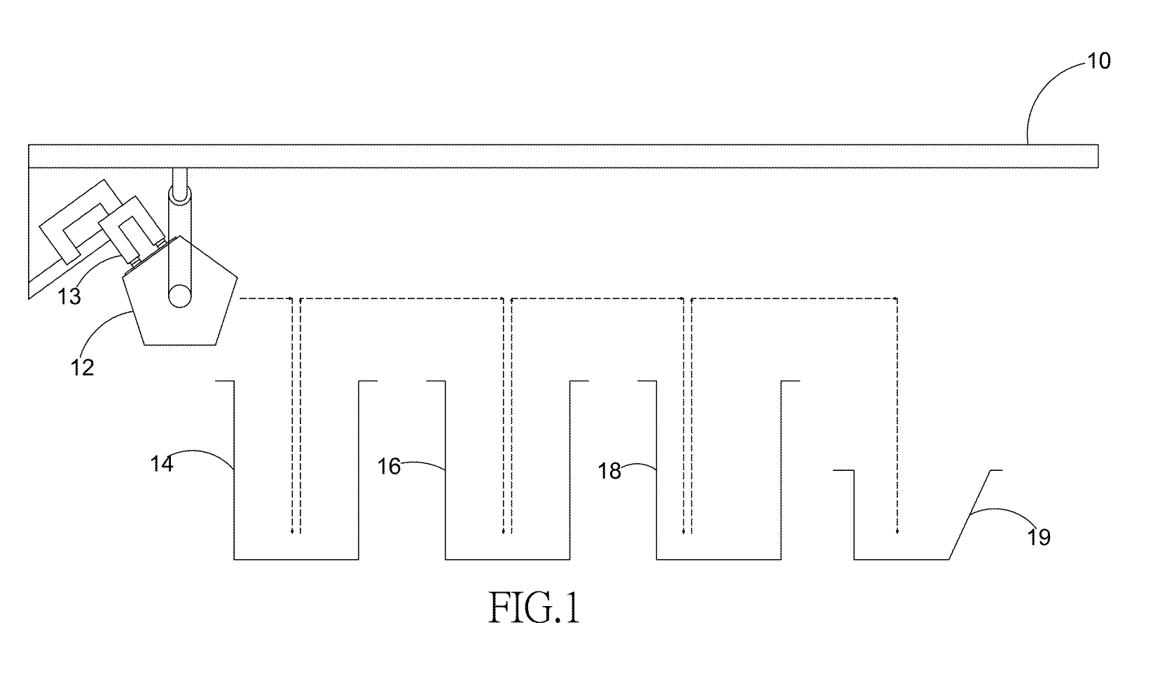

Refer to FIG. 1, a schematic drawing of an embodiment according to the present invention is revealed. A precious metal recovery device 1 of the present invention includes a conveying device 10, at least one loader 12, a robot arm 13, an immersion device 14, at least one dissolver 16 and at least one water cleaning device 18. The conveying device 10 is a crane that sends the loader 12 into the immersion device 14, the dissolver 16 or the water cleaning device 18.

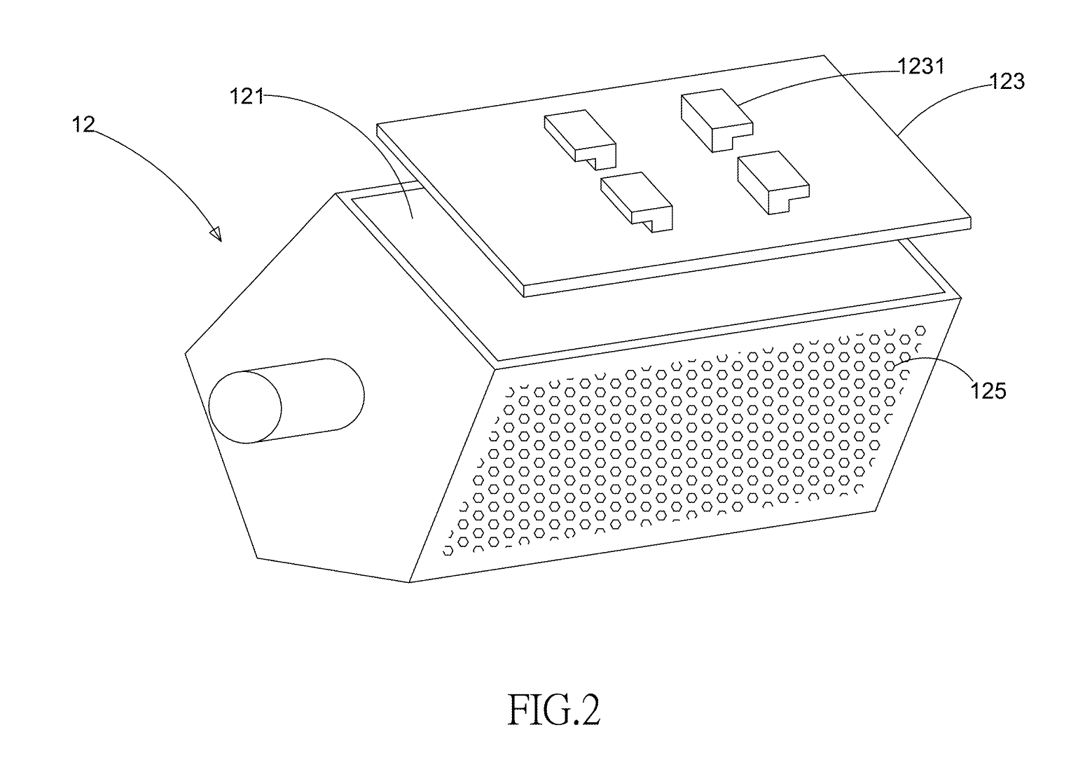

Refer to FIG. 2, the loader 12 is a container for loading objects with precious metal, as shown in figure. The loader 12 is a pentagonal prism with an opening 121 and a cover 123. The cover 123 is disposed with a clamping member 1231. The robot arm 13 holds the clamping member 1231 so as to move and open the cover 123. After the objects with precious metal being put into the loader 121 through the opening 121, the robot arm 13 puts the cover 123 back to cover the opening 121. The loader 12 includes a plurality of screen apertures 125. By the conveying device 10, the loader 12 is sent to the immersion device 14 that is filled with a solution. The solution is water. When the loader 12 with the objects having precious metal is soaked in the solution of the immersion device 14 filled with solution, the solution enters the loader 12 through the screen apertures 125. The objects with precious metal are infiltrated and broken down by the solution. In order to prevent the objects from attaching or adhering to inner surfaces of the loader 12 before being pulled out from the loader 12, the inner surfaces of the loader 12 are arranged with a plurality of projecting spots (not shown in figure).

After being immersed in the immersion device 14, the loader 12 is pulled out from the immersion device 14 and then is sent to the dissolver 16 by the conveying device 10. The dissolver 16 is filled with a solvent which dissolves at least one precious metal in the objects. After being soaked into the dissolver 16, the solvent dissolves most of the precious metal contained in the objects in the loader 12 and only a small amount of precious metal is left in the objects in the loader 12.

Next the loader 12 is moved out of the dissolver 16 and is sent to the water cleaning device 18 by the conveying device 10. The water cleaning device 18 washes the objects with a small amount of precious metal and cleans residual on the surface of the objects. Thus the precious metal is recovered from the solvent of the dissolver 16 and the water cleaning device 18. The precious metal recovery device 1 can include a plurality of loaders 12 that are treated by the steps of immersion, dissolution, and water cleaning in order by the conveying device 10.

Finally, the loader 12 with the objects having only a small amount of precious metal is sent to a material discharge device 19 by the conveying device 10. The robot arm 13 grips the clamping member 1231 on the cover 123 of the loader 12 to open and move the cover 123. Then the objects in the loader 12 are dumped into the material discharge device 19. A plurality of projecting spots (not shown in figure) is also arranged on inner surfaces of the material discharge device 19 so as to avoid the attachment or adhesion of the objects to the material discharge device 19.

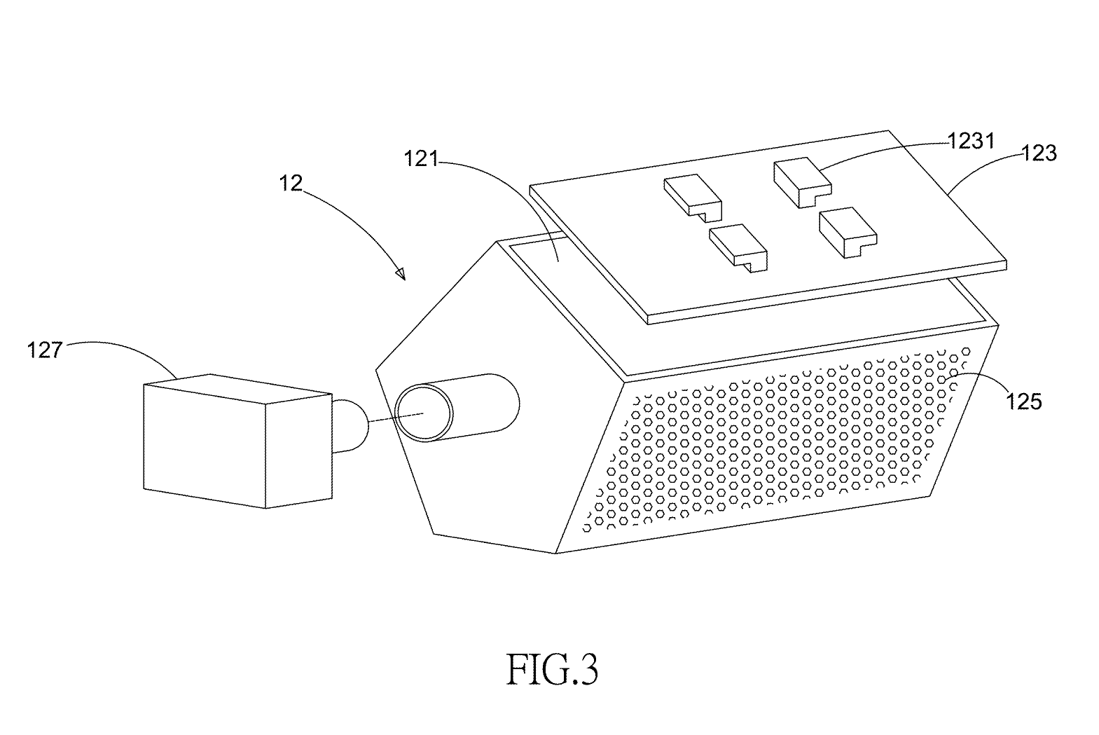

Refer to FIG. 3, another embodiment of the loader 12 is revealed. As shown in figure, in order to have the objects with precious metal being immersed, infiltrated, dissolved, and cleaned more evenly, the loader 12 further includes a driving member 127 that drives the loader 12 rotating.

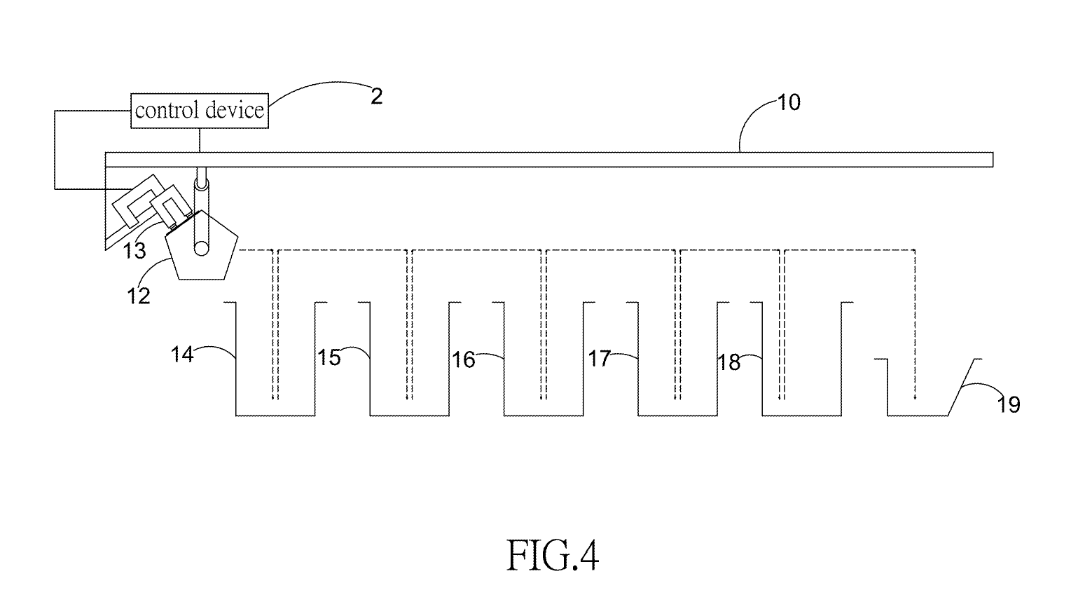

Refer to FIG. 4, another embodiment of an automatic recovery device of precious metal is disclosed. The difference of this embodiment and the above one in FIG. 1 is in that this embodiment of the precious metal recovery device further consists of a controller 2 so as to make the device become automatic equipment. The controller 2 is connected with the conveying device 10 and the robot arm 13. The controller 2 also controls the conveying device 10 to send the loader 12 and controls the robot arm 13 to grip the cover 123 of the loader 12. Furthermore, the controller 2 is in control of the driving member 127 of the embodiment in FIG. 3. Moreover, a standing device 15 is disposed between the immersion device 14 and the dissolver 16. Similarly, a standing device 17 is arranged between the dissolver 16 and the water cleaning device 18.

The controller 2 in control of the robot arm 13 makes the robot arm 13 grip the clamping member 1231 on the cover 123 of the loader 12 so as to open and move the cover 123. Then the objects containing precious metal is set into the loader 12 through the opening 1231. Next the controller 2 controls the robot arm 13 to hold the clamping member 1231 on the cover 123 of the loader 12 for moving the cover 123 to shield the opening 121 of the loader 12.

The conveying device 10 is used for sending the loader 12 to the immersion device, the dissolver 16 or the water cleaning device 18. The loader 12 is to receive at least one object with precious metal. The loader 12 with the objects having precious metal is sent to the immersion device 14 by the conveying device 10. The immersion device 14 is filled with a solution which is water. When the loader 12 with the objects having precious metal is soaked in the solution of the immersion device 14, the objects with metal is infiltrated and is broken down.

By the conveying device 10, the loader 12 is moved out of the immersion device 14 and is moved into the standing device 15, leave for a period of time. Then the conveying device 10 sends the loader 12 to the dissolver 16 filled with a solvent. The solvent being used can dissolve at least one precious metal of the objects. When the loader 12 is immersed in the dissolver 16 with the solvent, the solvent dissolves precious metal in the objects and only a small amount of precious metal is left in the objects.

Next the loader 12 soaked in the dissolver 16 is pulled out and is sent to the standing device 17 by the conveying device 10, leave for a period of time. The conveying device 10 sends the loader 12 with the objects having precious metal into the water cleaning device 18. The objects with precious metal in the loader 12 is washed and cleaned while residual precious metal on surfaces of the objects is moved out now. Thus the precious metal is recovered from the solvent of the dissolver 16 and the water cleaning device 18. The precious metal recovery device 1 can have a plurality of loaders 12 that are moved by the conveying device 10 and treated by the steps of immersion, standing, dissolution, standing, and water cleaning in order.

Lastly, the conveying device 10 sends the loader 12 with the objects having only a small amount of precious metal to a material discharge device 19. The robot arm 13 clamps the clamping member 1231 on the cover 123 of the loader 12 to open and move the cover 123. Then the objects in the loader 12 are dumped into the material discharge device 19. The inner surfaces of the material discharge device 19 are also disposed with a plurality of projecting spots (not shown in figure) so as to avoid the attachment or adhesion of the objects to the material discharge device 19.

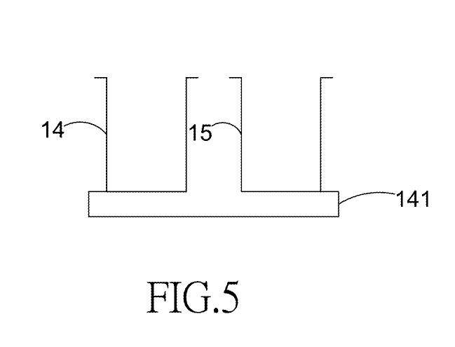

Refer to FIG. 5, a water drainage member of another embodiment according to the present invention is revealed. Together with the FIG. 4, the immersion device 14 as well as the standing device 15 is further disposed with a water drainage member 141. When the loader 12 is moved out from the immersion device 14, the solution in the immersion device 14 is drained into the water drainage member 141 from the bottom thereof. The standing device 15 is not filled with any solution so that most of the solution in the water drainage member 141 is from the immersion device 14. Both the immersion device 14 and the standing device are enclosed by the water drainage member 141. The height of the water drainage member 141 is able to be reduced.

In summary, a precious metal recovery device of the present invention features in continuous recovery of the precious metal. Moreover, the precious metal recovery device is automatic equipment so that the recovery speed is increased and the amount of precious metal recovered is improved. The loader is a pentagonal prism with an opening with large area on one side for convenience of loading objects containing precious metal. By the robot arm that removes the cover of the loader, the objects are put in or poured out conveniently so as to replace manual labor.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A precious metal recovery device comprising:
a robot arm;
a loader that is a pentagonal prism and having an opening and a cover on one side for receiving an object containing precious metal; the cover being fixed on the opening and being clamped by the robot arm so as to open the cover and load the object containing precious metal into the loader;
a conveying device disposed with the loader for conveying the loader;
an immersion device filled with a solution while the loader is soaked into the immersion device after the loader received with the object containing precious metal being sent to the immersion device by the conveying device;
at least one dissolver filled with a solvent that dissolves precious metal contained in the object after the immersed loader being removed to the dissolver for dissolution; and
at least one water cleaning device for washing the loader being dissolved and removing residual precious metal on the object so as to recover precious metal from the dissolver and the water cleaning device.

2. The device as claimed in claim 1, wherein inner surfaces of the loader are arranged with a plurality of projecting spots.

3. The device as claimed in claim 1, wherein the cover of the loader is disposed with a clamping member and the robot arm holds the clamping member so as to open and move the cover.

4. The device as claimed in claim 1, wherein the precious metal recovery device further includes
a material discharge device for receiving the object in the water-cleaned loader.

5. The device as claimed in claim 4, wherein a plurality of projecting spots is arranged on inner surfaces of the material discharge device.

6. The device as claimed in claim 1, wherein the conveying device is a crane.

7. The device as claimed in claim 1, wherein the precious metal recovery device further includes a controller connects with and controls the conveying device as well as the robot arm.

8. The device as claimed in claim 1, wherein the loader further includes a driving member that drives the loader rotating.

9. The device as claimed in claim 8, wherein the precious metal recovery device further includes a controller connects with and controls the conveying device, the driving member, and the robot arm.

10. The device as claimed in claim 1, wherein the loader includes a plurality of screen apertures.

11. The device as claimed in claim 1, wherein the solution filled in the immersion device is water.

12. The device as claimed in claim 1, wherein the solvent filled in the dissolver is replaceable according to precious metal contained in the object.

13. The device as claimed in claim 1, wherein a standing device is disposed between the immersion device and the dissolver.

14. The device as claimed in claim 12, wherein the precious metal recovery device further includes a water drainage member disposed under the immersion device and under the standing device.

15. The device as claimed in claim 1, wherein a standing device is further disposed between the dissolver and the water cleaning device.

16. The device as claimed in claim 4, wherein a standing device is further disposed between the water cleaning device and the material discharge device.
